(19) United States
(12) Patent Application Publication
(10) Pub. No.: US 2006/0203661 A1
(43) Pub. Date: Sep. 14, 2006

(54) Rewritable media and management methods thereof

(75) Inventors: Way-Zen Chen, Taipei City (TW); Yi-Kai Chen, Tainan (TW); Che-Kuei Hsu, Changhua County (TW)

Correspondence Address: BIRCH STEWART KOLASCH & BIRCH, PO BOX 747, FALLS CHURCH, VA, 22040-0747, US

(73) Assignee: ULEAD SYSTEMS,INC.

(21) Appl. No.: 11/288,243

(22) Filed: Nov. 29, 2005

(30) Foreign Application Priority Data
Mar. 11, 2005 (TW) 94107478

(51) Int. Cl. G11B 7/00

(52) U.S. Cl. 369/53.2

(57) ABSTRACT

Rewritable media, and management methods thereof. A rewritable medium comprises an application. When the rewritable medium is read by a device, the application is executed on the device, and writes data from the device to the rewritable medium, overwriting the application on the rewritable medium.

### CROSS REFERENCE TO RELATED APPLICATION

This application is related to copending application entitled “Medium Content Protection Method”, U.S. Ser. No. ______, filed on Aug. 2, 2005.

### BACKGROUND

The invention relates to rewritable media, and further to management methods that employ an application in a rewritable medium to edit, and store image data to the rewritable medium, and related devices.

In current image and video capture, digital cameras and video cameras have replaced traditional cameras using films. At the same time, with the change of data recording, the transmission of digital contents becomes one of the important broadcast manners of life.

To increase the variety of digital content, content providers develop related applications and material for users to extend and edit content. Users can use applications to apply specific material on the digital contents. For example, a photo can be added to a frame with cartoon characters, or digital video can be edited using specific applications and material.

Conventionally, to edit digital contents with visual or interactive effects, an editing application must be installed in a computer system. After the application is executed, the digital content is uploaded to the computer system from an external storage medium, capture device, or hard disk of the computer system, and the application is used to edit the digital content. If the contents are to be enhanced, additional material must be provided and applied thereto. After processing of the computer system and application, new digital content is generated, and recorded to other media. During the procedure, the application, digital content, and material are distributed on the hard disk, external storage medium, or networks, such that retrieval and integration of data are complicated. Additionally, media for recording the new content must be purchased, making the process inconvenient.

### SUMMARY

Rewritable media and management methods are provided. An application, material and edited content on the rewritable media can be integrated without installation procedure, enhancing operating convenience.

An embodiment of a rewritable medium comprises an application. When the rewritable medium is read by a device, the application is executed on the device, and writes data from the device to the rewritable medium, overwriting the application on the rewritable medium.

An embodiment of a rewritable medium comprises an application. When the rewritable medium is read by a device, the application is executed, without being installed on the device, allowing editing of data on the device.

In an embodiment of a management method for rewritable media, a rewritable medium is read by a device. An application is executed on the device, and writes data from the device to the rewritable medium, overwriting the application.

In an embodiment of a management method for rewritable media, a rewritable medium is read by a device. An application is executed, without being installed on the device, allowing editing of data on the device.

An embodiment of a device comprises a media reading/recording device, memory, a storage device comprising data, and a processing unit. The media reading/recording device reads a rewritable medium. The processing unit executes an application on the rewritable medium in the memory, and uses the application to write data to the rewritable medium via the media reading/recording device, overwriting the application on the rewritable medium.

An embodiment of a device comprises a media reading/recording device, memory, a storage device comprising data, and a processing unit. The media reading/recording device reads a rewritable medium. The processing unit executes an application on the rewritable medium in the memory, to edit the data.

Management methods for rewritable media may take the form of program code embodied in tangible media. When the program code is loaded into and executed by a machine, the machine becomes an apparatus for practicing the disclosed method.

### DESCRIPTION OF THE DRAWINGS

The aforementioned features and advantages will become apparent by referring to the following detailed description with reference to the accompanying drawings, wherein:

FIG. 1 is a schematic diagram illustrating an embodiment of a device;

FIG. 2 is a schematic diagram illustrating an embodiment of a rewritable medium;

FIG. 3 is a flowchart of an embodiment of a management method for rewritable media; and

FIG. 4 is a schematic diagram illustrating an embodiment of a rewritable medium after edition;

### DESCRIPTION

Rewritable media and management methods are provided.

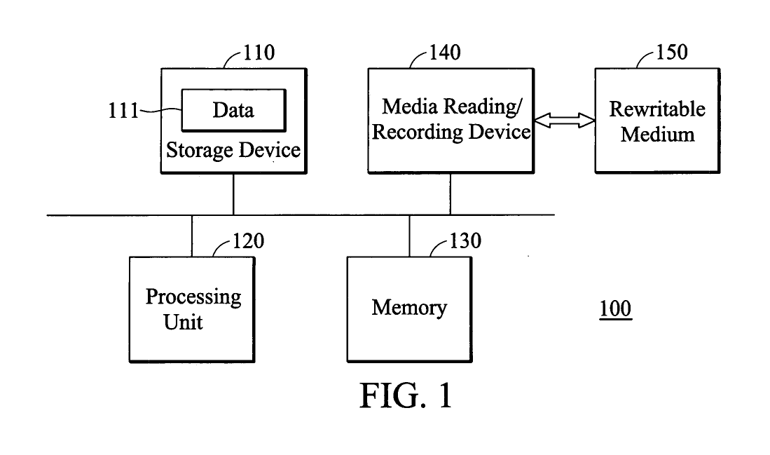

FIG. 1 is a schematic diagram illustrating an embodiment of a device. The device 100 comprises a storage device 110, a processing unit 120, memory 130, and a media reading/recording device 140. The device 100 may be a processor-based electronic device, such as a computer system. The storage device 110 comprises data 111, such as digital photos, videos, and others. The processing unit 120 performs the management methods for rewritable media of the invention. The media reading/recording device 140 reads information from a rewritable medium 150, and writes information thereto.

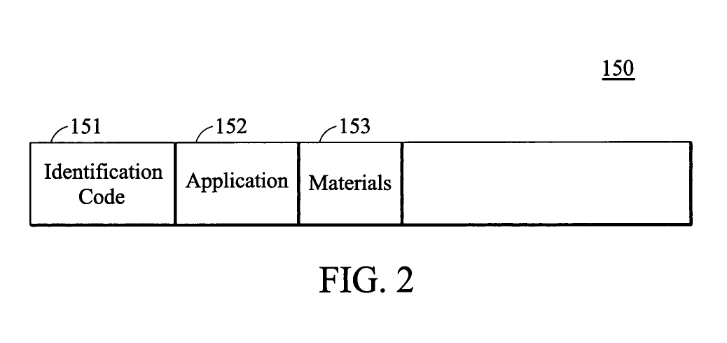

FIG. 2 is a schematic diagram illustrating an embodiment of a rewritable medium. The rewritable medium 150 may be a compact disc. The rewritable medium 150 comprises an identification code 151, an application 152, and materials 153. The identification code 151 records identification information of the manufacturer, and with usage thereof discussed later. The materials 153 may be templates or related data used for editing the data 111. When the application 152 is executed on the device 100, the materials 153 can edit the data 111. It is understood that, in some embodiments, the application 152 may have a data recording functionality to write the data 111 to the compact disc via the media reading/recording device 140.

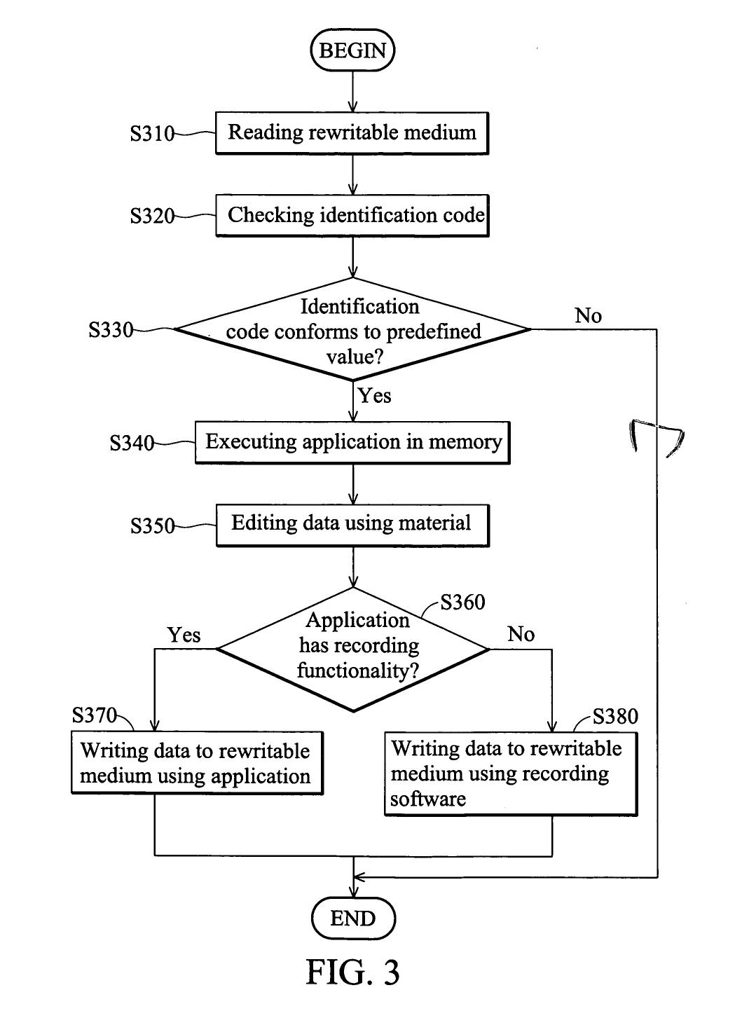

FIG. 3 is a flowchart of an embodiment of a management method for rewritable media.

In step S310, the media reading/recording device 140 of the device 100 reads the rewritable medium 150. In step S320, it is determined whether the identification code 151 conforms to a predefined value. It is understood that compact discs without authorization cannot be used after the determination in step S320. If not (No in step S330), the procedure is terminated. If so (Yes in step S330), in step S340, the application 152 on the rewritable medium 150 is executed in the memory 130 of the device 100. It is understood that, in some embodiments, the application 152 is executed in the memory 130 of the device 100, without being permanently installed in the storage device 110 of the device 100. In step S350, the data 111 is edited with the materials 153 on the rewritable medium 150 using the application 152. After the data 111 is edited, if the application 152 has recording functionality (Yes in step S360), in step S370, the edited data 111 is written to a rewritable medium using the application 152. If the application 152 does not have recording functionality (No in step S360), in step S380, the edited data 111 is written to a rewritable medium using recording software (not shown) of the device 100.

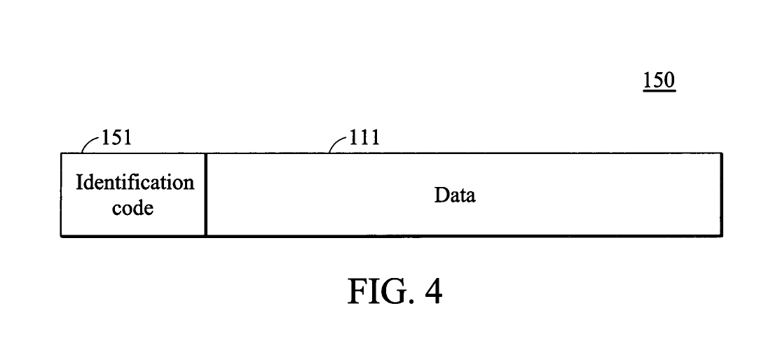

Note that the rewritable medium recording the edited data may be new or the original rewritable medium 150. If the edited data 111 is written to the original rewritable medium 150, the edited data 111 can be recorded in free areas of the rewritable medium 150, or overwrite application 152 and materials 153 on the rewritable medium 150, as shown in FIG. 4. In other words, in some embodiments, the application 152 and materials 153 on the rewritable medium 150 can be used only once.

Management methods for rewritable media, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those skilled in this technology can still make various alterations and modifications without departing from the scope and spirit of this invention. Therefore, the scope of the present invention shall be defined and protected by the following claims and their equivalents.

What is claimed is:

1. A rewritable medium, comprising:
an application,
wherein when the rewritable medium is read by a device, the application is executed on the device, and writes data from the device to the rewritable medium, overwriting the application on the rewritable medium.

2. The rewritable medium of claim 1, further comprising materials, wherein the application further uses the materials to edit the data, and writes the edited data to the rewritable medium, overwriting the application and materials on the rewritable medium.

3. The rewritable medium of claim 1, further comprising an identification code, wherein when the rewritable medium is read by the device, the device determines whether the identification code conforms to a predefined value, and if so, the application is executed on the device.

4. A rewritable medium, comprising:
an application,
wherein when the rewritable medium is read by a device, the application is executed, without being installed on the device, allowing editing of data on the device.

5. The rewritable medium of claim 4, wherein the application further writes the edited data to the rewritable medium, overwriting the application on the rewritable medium.

6. The rewritable medium of claim 4, further comprising materials, wherein the application further uses the materials to edit the data.

7. The rewritable medium of claim 6, wherein the application further writes the edited data to the rewritable medium, overwriting the application and materials on the rewritable medium.

8. The rewritable medium of claim 4, further comprising an identification code, wherein when the rewritable medium is read by the device, the device determines whether the identification code conforms to a predefined value, and if so, the application is executed on the device.

9. A management method for rewritable media, comprising:
reading a rewritable medium using a device;
executing an application from the rewritable medium on the device; and
writing data in the device to the rewritable medium, overwriting the application on the rewritable medium.

10. The method of claim 9, further comprising the application using materials to edit the data, and writing the edited data to the rewritable medium, overwriting the application and materials on the rewritable medium.

11. The method of claim 9, further comprising when the rewritable medium is read by the device, the device determining whether the identification code conforms to a predefined value, and if so, executing the application on the device.

12. A management method for rewritable media, comprising:
reading the rewritable medium using a device;
executing, but not installing the application on the device; and
editing data in the device.

13. The method of claim 12, further comprising the application writing the edited data to the rewritable medium, overwriting the application on the rewritable medium.

14. The method of claim 12, further comprising the application using materials to edit the data.

15. The method of claim 14, further comprising the application writing the edited data to the rewritable medium, overwriting the application and materials on the rewritable medium.

16. The method of claim 12, further comprising when the rewritable medium is read by the device, the device determining whether an identification code on the rewritable medium conforms to a predefined value, and if so, executing the application on the device.

17. A device, comprising:
a media reading/recording device reading a rewritable medium;
memory;
a storage device comprising data; and
a processing unit executing an application on the rewritable medium in the memory, and using the application to write data to the rewritable medium via the media reading/recording device, overwriting the application on the rewritable medium.

18. The device of claim 17, wherein the processing unit further reads materials on the rewritable medium via the media reading/recording device, edits the data using the application and materials, and writes the edited data to the rewritable medium, overwriting the application and materials on the rewritable medium.

19. The device of claim 17, wherein the processing unit further reads an identification code on the rewritable medium via the media reading/recording device, determines whether the identification code conforms to a predefined value, and if so, executes the application in the memory.

20. A device, comprising:
a media reading/recording device reading a rewritable medium;
memory;
a storage device comprising data; and
a processing unit executing an application on the rewritable medium in the memory to edit the data.

21. The device of claim 20, wherein the processing unit further uses the application to write the edited data to the rewritable medium via the media reading/recording device, overwriting the application on the rewritable medium.

22. The device of claim 20, wherein the processing unit further reads materials on the rewritable medium via the media reading/recording device, and edits the data using the application and materials.

23. The device of claim 22, wherein the processing unit further writes the edited data to the rewritable medium via the media reading/recording device, overwriting the application and materials on the rewritable medium.

24. The device of claim 20, wherein the processing unit further reads an identification code on the rewritable medium via the media reading/recording device, determines whether the identification code conforms to a predefined value, and if so, executes the application in the memory.
